(19) United States
(12) Patent Application Publication
(10) Pub. No.: US 2014/0095169 A1
(43) Pub. Date: Apr. 3, 2014

(54) VOICE AUTHENTICATION SYSTEM AND METHODS

(71) Applicant: Clive Summerfield, Hornsby (AU)

(72) Inventor: Clive Summerfield, Hornsby (AU)

(73) Assignee: AURAYA PTY LTD, Dickson, Australian Capital Territory (AU)

(21) Appl. No.: 13/996,187

(22) PCT Filed: Dec. 19, 2011
(86) PCT No.: PCT/AU2011/001630

§ 371 Date: Dec. 5, 2013

(30) Foreign Application Priority Data
Dec. 20, 2010 (AU) 2010905558

(51) Int. Cl. G10L 17/00

(52) U.S. Cl. CPC G10L 17/005
USPC 704/273

(57) ABSTRACT

A method for enrolling a user with a voice authentication system comprises obtaining a voice sample which has been used to authenticate a user using a first authentication process. The voice sample is subsequently utilised to enroll the user with an authentication system implementing a second authentication process.

### FIELD OF THE INVENTION

The present invention relates generally to voice authentication systems.

### BACKGROUND OF THE INVENTION

Voice authentication systems are becoming increasingly popular for providing secure access control. For example, voice authentication systems are currently being utilised in telephone banking systems, automated proof of identity applications, in call centres systems (e.g. deployed in banking financial services), building and office entry access systems and the like.

Voice authentication is typically conducted over a telecommunications network, as a two stage process. The first stage, referred to as the enrolment stage, involves processing a sample of a person's voice presented by a voice authentication engine to generate an acoustic model or “voiceprint” that represents acoustic parameters unique to that person's voice. The second stage, or authentication stage, involves receiving a voice sample of a person to be authenticated (or identified) over the network. Again, the voice authentication engine generates an acoustic model of the sample and compares the resultant parameters with parameters of the stored voiceprint to derive an authentication score indicating how closely matched the two samples are (and therefore the likelihood that the person is, in fact, the same as that being claimed). This score is typically expressed as a numerical value or score and involves various mathematical calculations that can vary from engine to engine.

In the case of the correct, or “legitimate”, person accessing the authentication system, the expectation is that their voiceprint (i.e. generated from their voice sample) will closely match the voiceprint previously enrolled for that person, resulting in a high score. If a fraudster (often referred to in the art as an “impostor”) is attempting to access the system using the legitimate person's information (e.g. voicing their password, etc), the expectation is that the impostor's voiceprint will not closely match the legitimate person's enrolled voiceprint, thus resulting in a low score even though the impostor is quoting the correct information.

The format of the parameters that comprise a voiceprint and the acoustic information represented by such parameters is proprietary to each type of technology or product used to implement the voice authentication system. Further, voiceprints and the parameters that comprise the voiceprint are often encrypted to protect the acoustic information that is used to authenticate a speaker's identity. Therefore, the database of enrolled voiceprints that is created in a voice authentication system is often specific to a particular vendor's technology and to a specific implementation or deployment of that technology. Thus, a database of voiceprints created in one system is often not transferable or usable by a voice authentication system used in another system or application.

As a consequence, when the voice authentication system is replaced, upgraded, or changed, it is often necessary to re-enroll all the speakers (as described above) in order to create a new database of voiceprints that is compatible with the new voice authentication system. This re-enrolment can be highly inconvenient for the speakers as each speaker enrolled in the previous system will need to go through the process of enrolling their voice over again. Furthermore, the re-enrolment process can be very time consuming and expensive, especially if the number of speakers enrolled in the original system is large.

### SUMMARY OF THE INVENTION

In accordance with a first aspect, the present invention provides a method for enrolling a user with a voice authentication system, the method comprising:
obtaining a voice sample which has been used to authenticate a user using a first authentication process;
utilising the voice sample to enroll the user with an authentication system implementing a second authentication process.

In an embodiment the step of enrolling the user comprises processing the voice sample to generate a voiceprint which is stored by the authentication system in association with a user identifier.

In an embodiment the voice sample is obtained from a request to access a secure service processed by the first authentication process.

In an embodiment the method further comprises processing further requests to access the secure service using the second authentication process, in response to determining that the voiceprint meets a predefined performance criterion.

In an embodiment, in response to determining that the voiceprint does not meet the predefined performance criteria, the method further comprises obtaining a sufficient number of further voice samples authenticated using the first authentication process to generate a voiceprint which meets the predefined performance criteria.

In an embodiment the method comprises the further step of obtaining the further voice sample(s) from the same request to access the secure service.

In an embodiment the method comprises the further step of instructing an interactive voice response system to ask the user to provide the further voice sample(s) during the request.

In an embodiment the method comprises the further step of obtaining the further voice sample(s) from one or more separate authentication requests processed using the first authentication process.

In an embodiment the performance criteria is that a false acceptance parameter value for the voiceprint when processed using the second authentication process is equal to or less than either a false acceptance parameter value for the voiceprint when processed using the first authentication process or a predefined value.

In an embodiment the false acceptance parameter is a rate at which the authentication process incorrectly evaluates at least one impostor voice sample as being associated with the enrolled person.

In an embodiment the performance criteria is that a false rejection parameter for the voiceprint when processed using the second authentication process is lower than or equal to either a false rejection parameter value for the voiceprint when processed using the first authentication process or a predefined value.

In an embodiment the false acceptance parameter is a rate at which the authentication process incorrectly evaluates at least one legitimate voice sample as not being associated with the enrolled person.

In an embodiment the method further comprises storing the voiceprint in an enrolment database accessible by the authentication system implementing the second authentication process.

In an embodiment the method further comprises obtaining at least one user identifier associated with the authentication request which is associated with the stored voiceprint for enrolling the user with the authentication system.

In an embodiment the first authentication process utilises at least one different authentication parameter such as an algorithm or engine than the second authentication process.

In accordance with a second aspect of the present invention there is provided an enrolment system for enrolling a user with a voice authentication system, the enrolment system comprising:
a processor arranged to implement:
   an interface module adapted to interface with a voice sample source to obtain a voice sample associated with an authentication request and which has been authenticated using a first authentication process; and
   an enrolment module adapted to utilise the obtained voice sample to enroll the user with a voice authentication system implementing a second authentication process.

In an embodiment the voice authentication system comprises an authentication module arranged to implement the second authentication process.

In an embodiment the second authentication module is arranged to process the voice sample to generate a voiceprint which is stored by the voice authentication system in an enrolment database and subsequently utilised by the voice authentication system to authenticate the user.

In an embodiment the interface module is further arranged to extract a user identifier from the authentication request and store the user identifier in association with the enrolled voiceprint.

In an embodiment the second authentication module is arranged to process further authentication requests based on the voiceprint, in response to determining that the voiceprint meets a predefined performance criterion.

In an embodiment, in response to determining that the voiceprint does not meet the predefined performance criteria, the interface module is arranged to obtain a sufficient number of further voice samples authenticated using the first authentication process to generate a voiceprint which meets the predefined performance criteria.

In an embodiment the interface module is arranged to obtain the further voice sample(s) from the same request to access the secure service.

In an embodiment the interface module is arranged to obtain the further voice sample(s) from one or more separate authentication requests processed using the first authentication process.

In an embodiment the performance criteria is that a false acceptance parameter value for the voiceprint when processed using the second authentication process is equal to or less than either a false acceptance parameter value for the voiceprint when processed using the first authentication process or a predefined value.

In an embodiment the false acceptance parameter is a rate at which the authentication process incorrectly evaluates at least one impostor voice sample as being associated with the enrolled person.

In an embodiment the performance criteria is that a false rejection parameter for the voiceprint when processed using the second authentication process is lower than or equal to either a false rejection parameter value for the voiceprint when processed using the first authentication process or a predefined value.

In an embodiment the false acceptance parameter is a rate at which the authentication process incorrectly evaluates at least one legitimate voice sample as not being associated with the enrolled person.

In an embodiment the first authentication process utilises at least one different authentication algorithm or engine than the second authentication process.

In an embodiment the method further comprises an output module arranged to output an authentication score associated with each processed further authentication request to a secure service provider, the secure service provider arranged to utilise the authentication score to determine whether to allow the user access to a secure service.

In accordance with an third aspect the present invention provides a computer program comprising at least one instruction for controlling a computing system to implement a method in accordance with the first aspect.

In accordance with a fourth aspect the present invention provides a computer readable medium providing a computer program in accordance with the fourth aspect.

### BRIEF DESCRIPTION OF THE DRAWINGS

Features and advantages of the present invention will become apparent from the following description of embodiments thereof, by way of example only, with reference to the accompanying drawings, in which:

FIG. 1 is a block diagram of a system in accordance with an embodiment of the present invention;

FIG. 2 is a schematic of the individual modules implemented by an enrolment and authentication server of FIG. 1;

FIG. 3 is a basic process flow for carrying out an embodiment of the present invention;

FIG. 4 is a flow diagram illustrating an access request process; and

FIG. 5 is a flow diagram showing the method steps for enrolling, in accordance with an embodiment of the invention.

### DETAILED DESCRIPTION OF PREFERRED EMBODIMENTS

For the purposes of illustration, and with reference to the figures, embodiments of the invention will hereafter be described in the context of a voice authentication system for a secure service, such as a secure interactive voice response (“IVR”) telephone service provided by a bank. Users communicate with the secure service using an input device in the form of a telephone (e.g. a standard telephone, mobile telephone or IP telephone service such as Skype).

Embodiments are directed to systems and methods for conveniently upgrading or transitioning voice authentication systems to a new platform which utilises a different authentication process that is unable to make use of the existing enrolment/authentication data. More specifically, embodiments outlined herein are advantageously able to complete the transition without requiring systematic re-enrolment of customer voice data before the new or upgraded system can be made operational. In the illustrated embodiment, the term “authentication process” refers to a particular form of authentication engine (or engines) implemented by the authentication system. However, it will be understood by persons skilled in the art that the term can include within its scope any hardware or software process which utilises enrolment data to produce an authentication result.

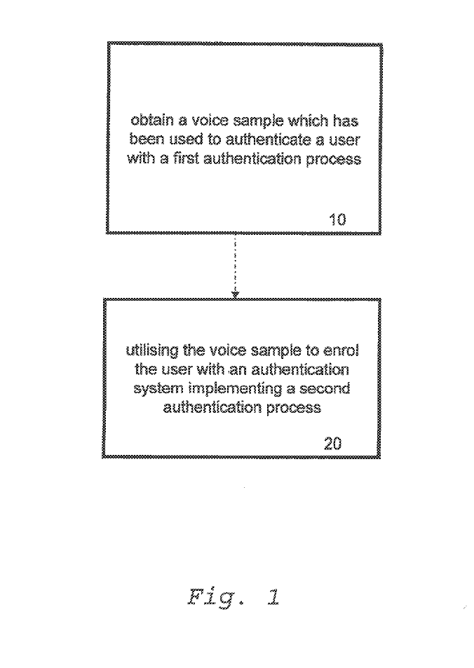

With reference to FIG. 1, in a basic form, the methodology comprises obtaining a voice sample which has been used by the existing authentication system to successfully authenticate a user of the system (step 10). The authentication is made by referencing enrolment data (and more specifically an enrolled voiceprint) generated when the user initially enrolled with the system. Generally, the voice sample will be extracted from an authentication request placed with the existing authentication system for accessing the secure service. At step 20, the voice sample is then advantageously utilised to enroll the user with the new or upgraded authentication system which implements a different authentication process which is incompatible with the enrolment data stored by the existing system.

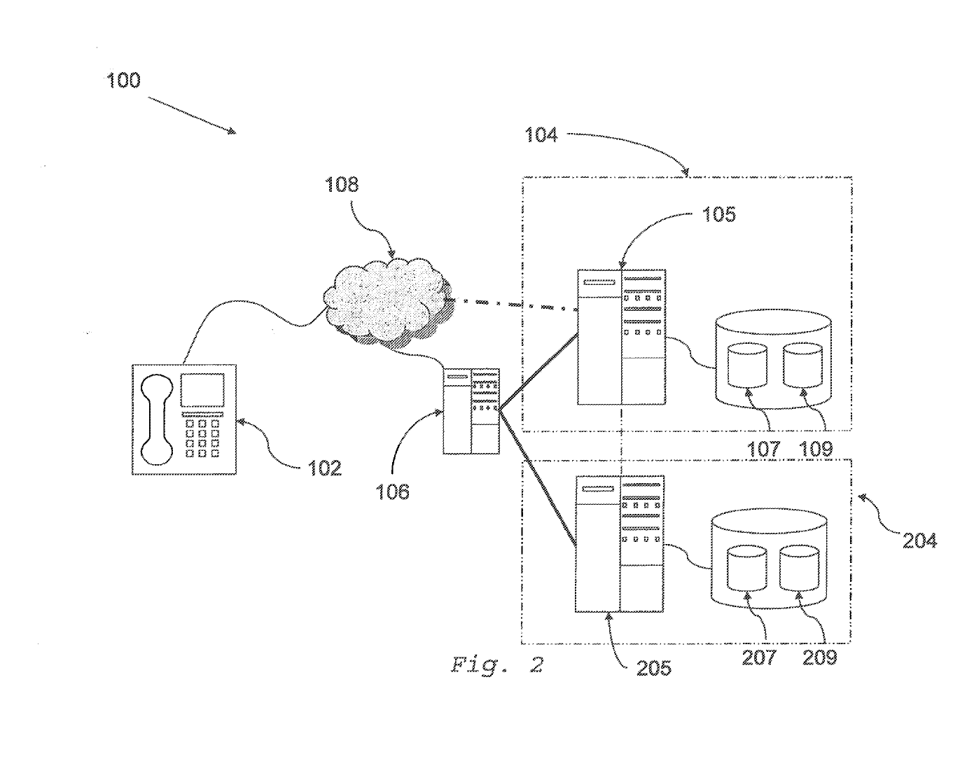

FIG. 2 illustrates an example system configuration 100 for implementing an embodiment of the present invention.

The system 100 includes a user input device 102 in the form of a standard telephone; a first authentication system 104 (hereafter “existing authentication system”) implementing a first authentication process; a second authentication system 204 (hereafter “new authentication system”) implementing a second authentication process which is different to the first authentication process; a secure service provider system 106 in the form of a banking application server hosting a secure service application; and communications system 108, in the form of a public-switched telephone network.

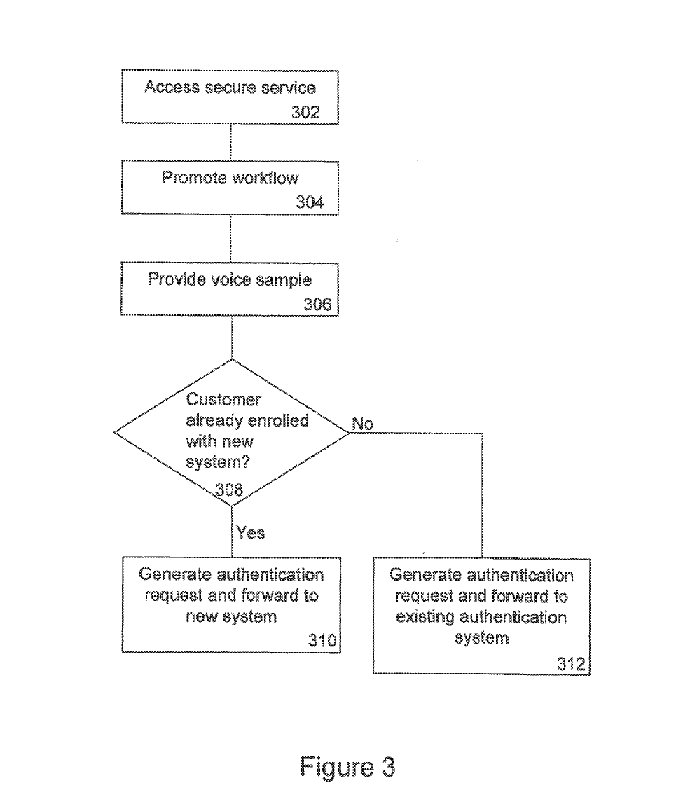

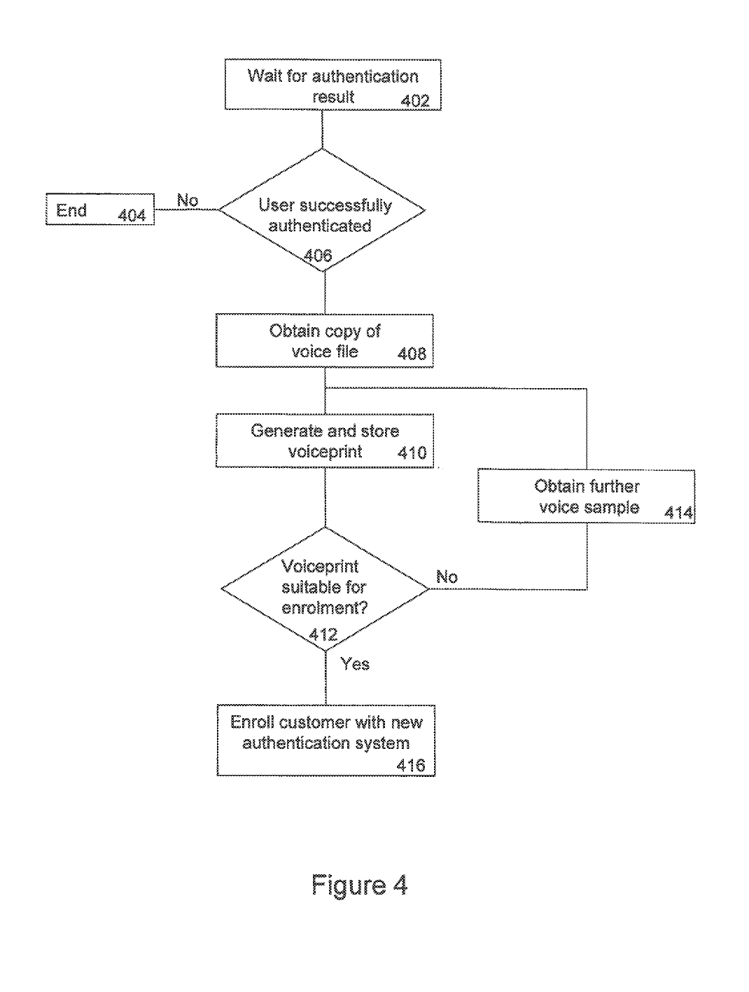

With reference to FIGS. 3 and 4 there is shown a more detailed process flow for implementing an embodiment of the present invention utilising the system of FIG. 2.

### Access to Secure Service

With reference to the flow diagram 300 of FIG. 3, an initial step (step 302) involves a purported customer (hereafter “speaker”) dialling the secure service provider using their telephone 102. Once connected, the speaker identifies themselves to the secure service provider system 106 (e.g. by keying in their customer account number, or other suitable identifying information) and places a request to access a secure service (step 304). For example, the speaker may ask to be connected to an operator to discuss matters relating to their account. Again, the request may be placed by making an appropriate keypad selection on their telephone 102. In an alternative embodiment, the speaker may voice their identification information and request which is processed and recognised by a speech recognition system.

At step 306, an interactive voice recognition (IVR) module implemented by the secure service system 106 asks the speaker to provide a voice sample for authentication. The IVR module may, for example, ask the speaker to confirm their account number or the like. The speaker then voices the requested information which is received and temporarily stored as a voice file by the secure service system 106 in an appropriate data store.

At step 308, the secure service system 106 communicates the customer identifier to the new authentication system 204 which processes the identifier to determine whether the customer associated with the customer identifier is already enrolled with the new system 204. This may be achieved, for example, by inspecting a look-up table maintained by the new system 204 which lists enrolled customers. The findings of the determination are then communicated back to the secure service system 106.

If, at step 308, it is determined that the customer associated with the customer identifier has been enrolled with the new system 204, the IVR module packages the temporarily stored voice file in an authentication request which is placed with new authentication system 204 for subsequent processing at step 310 (i.e. to generate an authentication score which can be used by the secure service system 106 to determine whether to allow the speaker access to the secure service using conventional techniques based on predefined thresholds, business rules, etc.).

In an embodiment, the basic process for generating an authentication score comprises performing an acoustic analysis of the voice file speech signal to produce a sequence of acoustic vectors representing the relevant voice characteristics for statistical analysis and comparison. Statistical pattern matching algorithms operating in the authentication engine implemented by the existing authentication system 104 compare the sequence of acoustic vectors with an existing customer voiceprint (i.e. generated and stored by the existing system during initial enrolment with the system) to generate a probability score representing how well the voice signal matches the legitimate voiceprint model. Such pattern matching algorithms include dynamic time warping (DTW), the hidden Markov model (HMM), among others.

If, on the other hand, it is determined at step 308 that the associated customer is not enrolled with the new system 204, an authentication request (generated as above in step 310) is placed with the existing authentication system 104 at step 312. The existing authentication system 104 subsequently processes the request and outputs an authentication score which, again, is used by the secure service system 106 to determine whether the speaker is to be allowed access to the secure service. In an alternative embodiment, the existing authentication system 104 may make the decision on behalf of the secure service and simply generate a yes or no type instruction which is communicated to the secure service system 106.

Enrolment with New Authentication System

With additional reference to FIG. 4, the enrolment process 400 will now be described in more detail. The process begins at step 402 where, in response to determining that the associated customer has not been enrolled with the new authentication system (see step 308 of FIG. 3), the new system 204 waits to determine whether the speaker was successfully authenticated by the existing authentication system (i.e. and thus are who they say they are). This may involve either periodically querying the secure service system 106 (or existing authentication system 104) for the authentication result, or alternatively waiting for the result to be automatically forwarded to the new authentication system 204. In yet another alternative embodiment, the new authentication system 204 may make the determination itself utilising the authentication score output from the existing authentication system (e.g. determining whether the authentication score exceeds an acceptable threshold, or based on some other suitable authentication criteria).

If at step 404 it is determined that the speaker failed to authenticate themselves (e.g. the score was less than the acceptable threshold level), the enrolment process stops on the assumption that the speaker is an impostor and thus the voice sample obtained from the authentication request should not be used for enrolment of the purported customer. See step 406.

However, if at step 404 the new authentication system establishes that the speaker has successfully authenticated themselves (i.e. they are in fact deemed to be the purported customer), then the new authentication system obtains a copy of the voice sample/file for enrolling the customer with the new authentication system (step 408). The voice sample may be obtained, for example, by sending a request to the secure service system 106 which is temporarily storing the voice file. Alternatively, the secure service system 106 may routinely forward a copy of the voice file (e.g. at the same time as sending the authentication request to the existing authentication system at step 314 of FIG. 3). It will be understood that the actual methodology for obtaining the authenticated voice file is not limited to those techniques described herein and any convenient technique may be utilised. Once obtained, the voice file is stored in the database 207.

In the illustrated embodiment, at step 410 the voice sample derived from the voice file is processed using the authentication process implemented by the new authentication system, to generate a new voiceprint suitable for use with the new system (i.e. using conventional techniques well known and understood in the art). The newly generated voiceprint is then stored in a voiceprint database 209 in association with the customer identifier, or other suitable identifying information, derived from either the secure service system or existing authentication system.

In most cases the newly enrolled voiceprint will be of sufficient quality to immediately be used by the new authentication system 204 for processing any subsequent authentication requests associated with the customer identifier (i.e. as described above). However, in some circumstances this will not be the case. For example, in some circumstances there may be a particularly high level of noise in the voice sample which may result in a poorly performing or “weak” voiceprint. Thus, in an embodiment, the newly enrolled voiceprint must pass certain performance tests before the system 204 will begin accepting authentication requests associated with the customer.

In a particular embodiment, the performance tests may involve evaluating performance criteria to determine whether the voiceprint exhibits sufficient performance characteristics (step 412). One criterion may be a false acceptance parameter value for the voiceprint when processed using the second authentication process. For example, the system 204 may evaluate the rate at which the authentication process implemented by the new system 204 incorrectly evaluates at least one impostor sample (e.g. a voice sample associated with a different customer stored in the database 207) as being associated with the enrolled customer. If the rate is equal to or less than the rate measured for the existing authentication system 104 (or some other predefined value), then the new system 204 may determine that the newly enrolled voiceprint is sufficiently strong and accept further authentication requests (step 416).

Another performance criterion may, for example, be based on a false rejection parameter. For example, the system 204 may evaluate the rate at which it incorrectly evaluates at least one legitimate voice sample (e.g. obtained from other authenticated samples provided by customer) as not being associated with the enrolled customer. Again, the threshold may be associated with the rate achieved by the existing system 104, or some other predefined value.

If the voiceprint does not pass the various performance tests, then one of a number of different optimisation actions may take place. According to the illustrated embodiment, the optimisation action involves instructing the IVR module to request a further voice sample from the speaker as part of the same authentication request (step 414). Once obtained, the new system 204 may process the sample (as described above) and again run performance tests on the new voiceprint to establish whether the relevant performance criteria have been met. If not, the system 204 may request and process still further samples until a sufficiently strong voiceprint has been generated. In an embodiment, the voiceprint may be generated from a combination of the obtained voice samples using techniques well known and understood in the art.

In an alternative embodiment to that described above, rather than requesting the further samples as part of the same authentication request, the new system 204 may obtain the samples from subsequent requests placed with the existing system 104 (i.e. as per the process flow outlined in FIG. 3). It will be understood that all voice samples obtained by the new system 204 may be stored in the voice sample database 207 in association with the customer identifier for subsequent use in generating the voiceprint.

In yet a still further alternative embodiment, rather than requesting additional samples, the new system may implement an optimisation action to improve either the performance of the voiceprint or the system. Such optimisation actions may, for example, include re-building the voiceprint, adjusting an individual authentication threshold score for the customer, etc. Various optimisation actions that would be suitable for use with embodiments described herein are outlined in the following published PCT application by the same applicant, the contents of which are incorporated herein by reference: PCT/AU2009/001165.

It will be appreciated that over time, as new access requests are placed by the existing customers, the new system 204 will continue to build the enrolment database 209 up to a point where all of the existing customers are enrolled with the new system 204. At this point, the existing system 104 may be decommissioned with all subsequent authentication requests handled by the new system operating alone. In an alternative embodiment, the transition may only be made in response to determining that the overall performance of the new system exhibits the same or better overall performance than the existing system. Various performance characteristics may be evaluated as part of such a determination including evaluating the equal error rate (EER) of both systems, etc.

### System Configuration

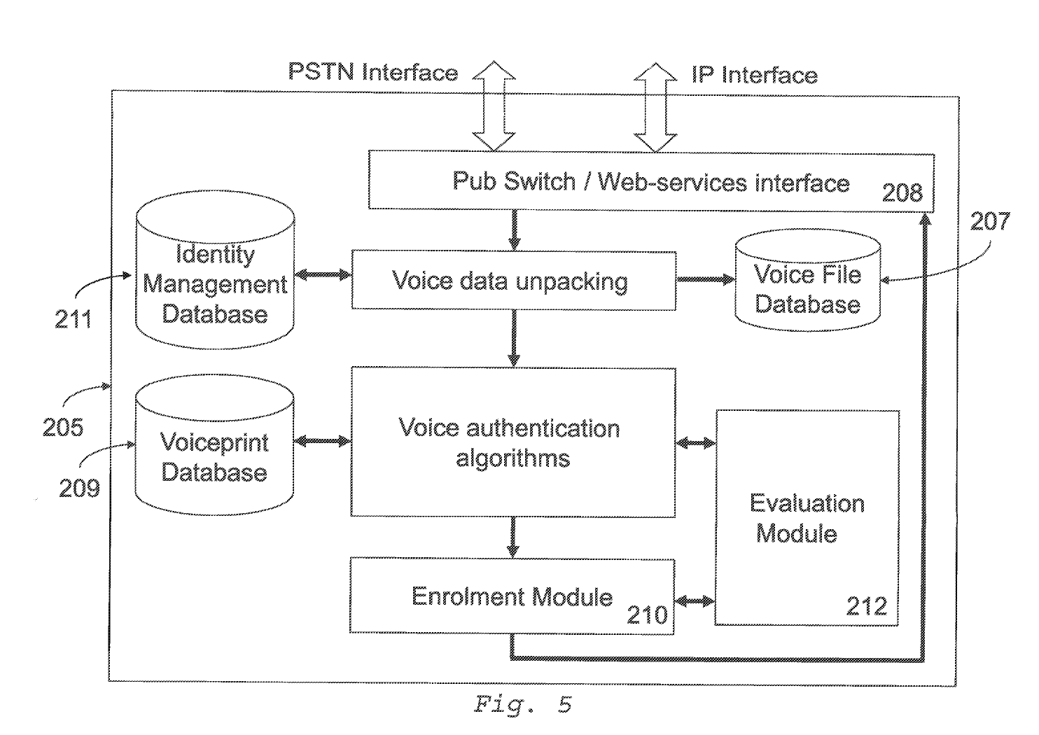

A more detailed explanation of the various modules implemented by the new authentication system 204 will now be described with reference to FIG. 5.

As mentioned in preceding paragraphs, the system 204 comprises a server 205 which functions to both enroll existing and new customers with the new system and to facilitate authentication requests. To perform this functionality, the server 205 comprises computer hardware including a processor, motherboard, random access memory, hard disk and a power supply. The server 205 also includes an operating system which co-operates with the hardware to provide an environment in which software applications can be executed. In this regard, the hard disk of the server 205 is loaded with voice authentication software, such as the Auraya voice authentication model which is available from Auraya Solutions Pty Ltd, Australia. The hard disk is also loaded with an interface module 208 (for communicating with the secure service provider system 106 and existing authentication system 104) and an enrolment module 210 which operates in conjunction with the voice authentication software to enroll both existing and new customers, as herein before described. A performance evaluation module 212 is also provided for calculating the performance of newly enrolled voiceprints and implementing various optimisation actions previously described.

The server 205 is also coupled to a voice file database 207, voiceprint database 209, and identity management database 211. It will be understood that the communication between the new authentication system and the existing system/secure service system may be made over any suitable communications link, such as an Ethernet connection, a wireless data connection or public network connection. As previously mentioned, in an embodiment the initial voice samples (upon which the enrolment is based) are initially logged with the secure service provider 106 and subsequently passed over the communications link to the new system 204. Alternatively, the samples may be provided directly to the server 205 (in which case the server 105 would also implement a suitable call answering service).

It will be appreciated that the existing authentication system 104 will necessarily implement many of the same modules as the new system 204 for communication and authentication purposes (albeit using different authentication processes, engines, etc). Thus, the basic system configuration will look much the same as for the new authentication system shown in FIG. 2 and for illustrative convenience will not be described in any further detail.

With reference back to FIG. 1, the communication system 108 is in the form of a public switched telephone network. However, in alternative embodiments the communications network may be a packet-switched network, such as the Internet. In such an embodiment customers may use a networked computing device to exchange data (more particularly, XML code and packetised voice messages) with either of the servers 105, 205 using a packet-switched network protocol, such as the TCP/IP protocol. Further details of such an embodiment are outlined in the international patent application PCT/AU2008/000070, the contents of which are incorporated herein by reference. In another alternative embodiment, the communication system may additionally comprise a third generation (“3G”) or GPRS enabled mobile telephone network connected to the packet-switched network which can be utilised to access the servers 105, 205. In such an embodiment, the customer input device 102 would include wireless capabilities for transmitting the voice message. The wireless computing devices may include, for example, mobile phones, personal computers having wireless cards and any other mobile communication device which facilitates voice recordal functionality. In another embodiment, the present invention may employ an 802.11 based wireless network or some other personal virtual network.

The other element in the system 100 is the secure service provider system 106 which, according to the embodiment described herein, is in the form of an Internet banking server. The secure service provider system 106 comprises a transceiver in the form of a network card for communicating with each of the customers, existing authentication system 104 and new authentication system 106. The server also includes appropriate hardware and/or software for providing an answering service. In the illustrated embodiment, the secure service provider 106 communicates with the customers 102 over a public-switched telephone network 108 utilising the transceiver module.

According to the illustrated embodiment, the secure service provider system 106 also maintains a database 120 arranged to temporarily store voice samples associated with authentication requests placed with the system. An interface module 122 may be implemented by the system 106 which stores rules associated with forwarding of authentication requests and customer identification data, as previously described.

Although in embodiments described in preceding paragraphs the authentication systems 104, 105 are in the form of a “third party”, or centralised system, it will be understood that the systems 104, 105 need not be third party systems and instead may be integrated into the secure service provider system 106.

While the invention has been described with reference to the present embodiment, it will be understood by those skilled in the art that alterations, changes and improvements may be made and equivalents may be substituted for the elements thereof and steps thereof without departing from the scope of the invention. In addition, many modifications may be made to adapt the invention to a particular situation or material to the teachings of the invention without departing from the central scope thereof. Such alterations, changes, modifications and improvements, though not expressly described above, are nevertheless intended and implied to be within the scope and spirit of the invention. Therefore, it is intended that the invention not be limited to the particular embodiment described herein and will include all embodiments falling within the scope of the independent claims.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method for enrolling a user with a voice authentication system, the method comprising:
obtaining a voice sample which has been used to authenticate a user based on a first authentication process;
utilizing the voice sample to enroll the user with an authentication system implementing a second authentication process.

2. A method as claimed in claim 1, wherein the step of enrolling the user comprises processing the voice sample to generate a voiceprint which is stored in association with a user identifier.

3. A method as claimed in claim 2, wherein the voice sample is obtained from a request to access a secure service processed by the first authentication process.

4. A method as claimed in claim 3, further comprising processing further requests to access the secure service using the second authentication process, in response to determining that the voiceprint meets a predefined performance criteria.

5. A method as claimed in claim 4, further comprising, in response to determining that the voiceprint does not meet the predefined performance criteria, obtaining a sufficient number of further voice samples authenticated using the first authentication process to generate a voiceprint which meets the predefined performance criteria.

6. A method as claimed in claim 5, comprising the further step of obtaining the further voice sample(s) from the same request to access the secure service.

7. A method as claimed in claim 6, comprising the further step of instructing an interactive voice response system to ask the user to provide the further voice sample(s) during the request.

8. A method as claimed in claim 5, comprising the further step of obtaining the further voice sample(s) from one or more separate authentication requests processed using the first authentication process.

9. A method as claimed in claim 4, wherein the performance criteria is that a false acceptance parameter value for the voiceprint when processed using the second authentication process is equal to or less than either a false acceptance parameter value for the voiceprint when processed using the first authentication process, or a predefined value.

10. A method as claimed in claim 9, wherein the false acceptance parameter is a rate at which the authentication process incorrectly evaluates at least one impostor voice sample as being associated with the enrolled person.

11. A method as claimed in claim 4, wherein the performance criteria is that a false rejection parameter for the voiceprint when processed using the second authentication process is lower than or equal to either a false rejection parameter value for the voiceprint when processed using the first authentication process, or a predefined value.

12. A method as claimed in claim 11, wherein the false acceptance parameter is a rate at which the authentication process incorrectly evaluates at least one legitimate voice sample as not being associated with the enrolled person.

13. A method as claimed in claim 2, further comprising (a) storing the voiceprint in an enrolment database accessible by the authentication system implementing the second authentication process and (b) obtaining at least one user identifier associated with the authentication request which is associated with the stored voiceprint for enrolling the user with the authentication system.

14. (canceled)

15. A method as claimed in claim 1, wherein the first authentication process utilizes at least one different authentication algorithm or engine than the second authentication process.

16. An enrolment system for enrolling a user with a voice authentication system, the enrolment system comprising:
a processor arranged to implement:
an interface module adapted to interface with a voice sample source to obtain a voice sample associated with an authentication request and which has been authenticated using first authentication process; and
an enrolment module adapted to utilize the obtained voice sample to enroll the user with a voice authentication system implementing a second authentication process.

17. An enrolment system as claimed in claim 16, wherein the voice authentication system comprises a second authentication module arranged to implement the second authentication process and wherein the second authentication module is arranged to process the voice sample to generate a voiceprint which is stored by the voice authentication system in an enrolment database and subsequently utilized by the voice authentication system to authenticate the user.

18. (canceled)

19. An enrolment system as claimed in claim 16, wherein the interface module is further arranged to extract a user identifier from the authentication request and store the user identifier in association with the enrolled voiceprint.

20. An enrolment system as claimed in claim 17, wherein the second authentication module is arranged to process further authentication requests based on the voiceprint, in response to determining that the voiceprint meets a predefined performance criteria.

21. An enrolment system as claimed in claim 20, wherein, in response to determining that the voiceprint does not meet the predefined performance criteria, the interface module is arranged to obtain a sufficient number of further voice samples authenticated using the first authentication process to generate a voiceprint which meets the predefined performance criteria.

22. An enrolment system as claimed in claim 21, wherein the interface module is arranged to obtain the further voice sample(s) from the same request to access the secure service.

23. An enrolment system as claimed in claim 21, wherein the interface module is arranged to obtain the further voice sample(s) from one or more separate authentication requests processed using the first authentication process.

24. An enrolment system as claimed in claim 20, wherein the performance criteria is that a false acceptance parameter value for the voiceprint when processed using the second authentication process is equal to or less than either a false acceptance parameter value for the voiceprint when processed using the first authentication process or a predefined value.

25. An enrolment system as claimed in claim 24, wherein the false acceptance parameter is a rate at which the authentication process incorrectly evaluates at least one impostor voice sample as being associated with the enrolled person.

26. An enrolment system as claimed in claim 20, wherein the performance criteria is that a false rejection parameter for the voiceprint when processed using the second authentication process is lower than or equal to either a false rejection parameter value for the voiceprint when processed using the first authentication process, or a predefined value.

27. An enrolment system as claimed in claim 26, wherein the false acceptance parameter is a rate at which the authentication process incorrectly evaluates at least one legitimate voice sample as not being associated with the enrolled person.

28. An enrolment system as claimed in claim 16, wherein the first authentication process utilises at least one different authentication algorithm or engine than the second authentication process.

29. An enrolment system as claimed in claim 20, further comprising an output module arranged to output an authentication score associated with each processed further authentication request to a secure service provider, the secure service provider arranged to utilise the authentication score to determine whether to allow the user access to a secure service.

30. (canceled)

31. (canceled)
